(19) United States
(12) Patent Application Publication
(10) Pub. No.: US 2022/0148105 A1
(43) Pub. Date: May 12, 2022

(54) FOOD ORDER AND DELIVERY PLATFORM AND METHOD

(71) Applicant: Kohlman-Rosenblith Group, LLC, Derry, NH (US)

(72) Inventors: Joe A. Rosenblith, Derry, NH (US); Patrick F. Kohlman, Windham, NH (US)

(73) Assignee: Kohlman-Rosenblith Group, LLC, Derry, NH (US)

(21) Appl. No.: 17/433,455

(22) PCT Filed: Feb. 24, 2020
(86) PCT No.: PCT/US20/19415

§ 371 Date: Aug. 24, 2021

Related U.S. Application Data
(60) Provisional application No. 62/809,905, filed on Feb. 25, 2019.

(51) Int. Cl. G06Q 50/12; G06Q 10/08

(52) U.S. Cl. CPC G06Q 50/12; G06Q 10/0832

(57) ABSTRACT

A food ordering and delivery system and method for increasing the speed and efficiency of service to customers by offering ready-to-deliver food to prospective customers based on their location relative to the ready-to-deliver food.

### FIELD OF THE INVENTION

The invention relates to food delivery, and, more particularly, to systems and methods of food delivery.

### BACKGROUND OF THE INVENTION

Existing systems and methods of on-demand food delivery, as contrasted from those used in connection with typically larger amounts of food ordered days or weeks in advance, are very inefficient. This inefficiency results in long wait times, substantial wear and tear on delivery vehicles, and increased costs, which are inevitably passed on to the end-customer.

For instance, during a typical day, a number of orders may be placed by customers with a food delivery service, with each order destined for a specific location within a certain radius of the restaurant providing the delivery services. Typically, these orders are requested to be delivered as soon as possible, resulting in wait times of between 0.5-1.5 hours. As the food must be delivered shortly following its preparation, to ensure its freshness, the number of orders which can be transported during a single delivery run are limited, both by the time that customers will tolerate waiting for their delivery and by the time that the food will remain fresh. Furthermore, in a given delivery run, the locations to which deliveries must be made may be relatively far away from each other.

Furthermore, because food ordered for delivery is typically made to order, problems arise when orders are cancelled.

All of these factors contribute to the inefficiency of the current system and methods of food order and deliver, resulting in less food served to fewer people, at greater cost than would be the case if ordering information was available to the restaurants in advance, allowing them to better plan food preparation and deliveries. However, requiring orders to be placed in advance would be expected to reduce the number of orders placed and therefore be unlikely to be cost-effective.

What is needed, therefore, are systems and methods that allow food delivery services to optimize deliveries, fill more orders in a given timeframe, and reduce costs while maintaining flexibility for customers to order when and what they want.

### SUMMARY OF THE INVENTION

One objective of the present disclosure is to allow food delivery services to better track what types of food customers are ordering at different times.

Another objective of the present disclosure is to provide food delivery services the ability to provide prospective customers real-time information regarding food availability and delivery routing.

Yet another objective of the present disclosure is to provide a service that connects prospective customers to multiple food delivery services through a single portal.

Yet still another objective of the present disclosure is to provide ordering systems and methods that provide prospective customers information regarding food that is already made and available for order.

Even yet another objective of the present disclosure is to reduce food waste generated by food delivery services.

Even still yet another objective of the present disclosure is to make food delivery more efficient.

An even further objective of the present disclosure is to allow any restaurant, regardless of size or style of cuisine, to prepare meals and deliver them to their customers in minutes.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a delivery system and method, in accordance with embodiments of the present invention;

FIG. 2 is a flowchart illustrating a delivery system and method, in accordance with embodiments of the present invention; and

FIG. 3 is a flowchart illustrating a delivery system and method from the perspective of a user thereof, in accordance with embodiments of the present invention.

### DETAILED DESCRIPTION

Disclosed herein is a food delivery system and method that increases food ordering and delivery efficiency while maintaining ordering flexibility for customers.

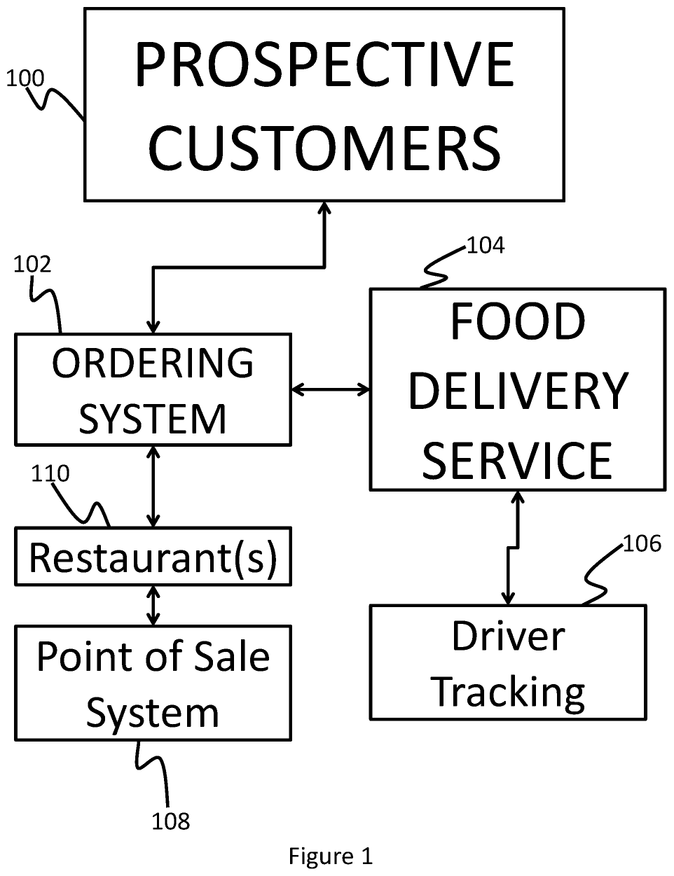

In one embodiment, such as that depicted in FIG. 1, prospective customers 100 are connected to at least one restaurant 110 and a food delivery service 104, which may or may not be the restaurant's own delivery service, through an ordering system 102. The at least one restaurant 110 provides information to the ordering system, in embodiments through a point of sale system 108 that contains a database of available items while the food delivery service provides location information regarding delivery vehicles to the ordering system through at least one driver tracking system 106. Each point of sale system 108, in embodiments, comprises information regarding available types of food, whether or not food is already prepared, and/or how long different types of food that require preparation will take to prepare. The driver tracking system 106, in embodiments, provides information regarding the current and/or anticipated future location of drivers, available food on hand, locations at which additional food, beverages, or other items can be purchased, number of stops before the drivers return to the food service provider, age of available food, and/or other pertinent information. By leveraging this information, the efficiency of food delivery can be increased while reducing waste and preserving customer choice.

For example, in embodiments, a prospective customer 100 accesses the ordering system 102 using a smart phone and app, web browser, or similar. Once the prospective customer 100 has accessed the ordering system 102, they are presented with a number of options. If they are interested in a particular type of food, they can select it from a list or using a search feature. Similarly, if a prospective customer 100 is interested in a single restaurant 110, a group of restaurants 110, restaurants 110 located within a certain area, food delivery available within a certain time frame, or other grouping, the prospective customer 100 may select this single service or grouping in the same way.

Whatever the prospective customer's 100 selection, once a selection is made, the prospective customer 100, in embodiments, is presented with a summary of available-to-order food corresponding to the prospective customer's 100 selection. In embodiments, information including estimated delivery times and pricing of the available-to-order food corresponding to the prospective customer's 100 selection is provided, with the information, in some cases, being derived from point of sale systems 108 associated with each food delivery service 104 or input manually by an employee. This information can be sorted in any way desired by the prospective customer 100. After placing an order, the customer may also be presented with a periodically-updated delivery time estimate, which may be provided in the form of a countdown timer.

Available-to-order fare comprises, in embodiments, pre-made food, made-to-order food, and unordered food that is currently in the possession of a delivery driver. In other embodiments, all food offered is already-prepared and ready to deliver.

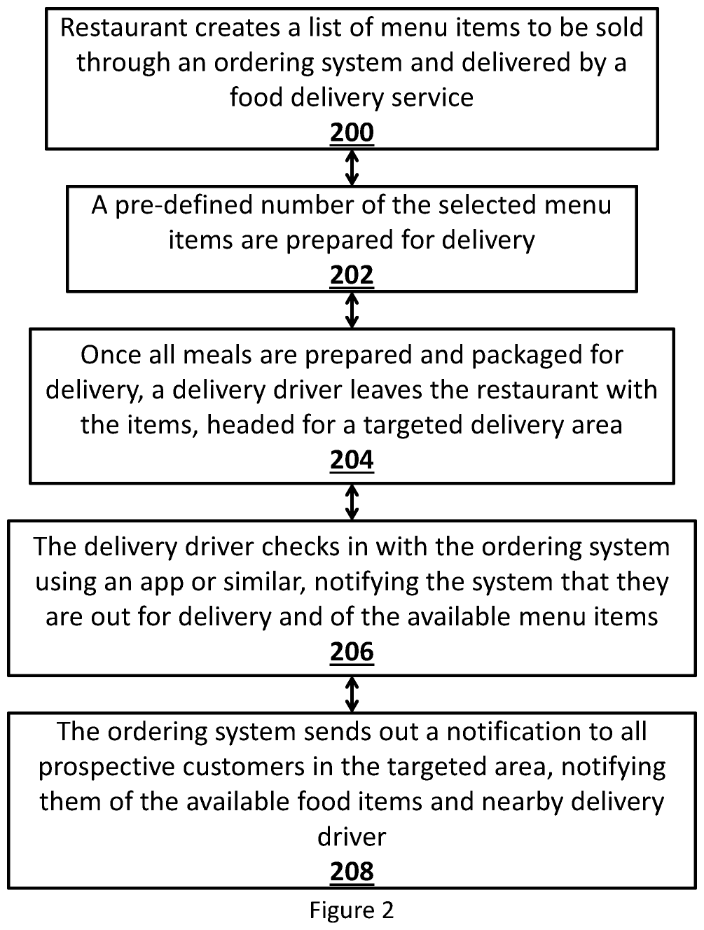

Now referring to FIG. 2, a flowchart illustrating a delivery system and method is depicted. More specifically, the method of FIG. 2 comprises: a restaurant 110 creating a list of menu items to be sold through the ordering system 102 of the food delivery service 104 (200); a pre-defined number of the selected menu items being prepared for delivery (202); a delivery driver leaving the restaurant 110 with the menu items and heading for a targeted delivery area, once the menu items are prepared and packaged for delivery (204); the delivery driver checking in with the ordering system 102, using an app or similar, and notifying the ordering system 102 that they are out for delivery and of the available menu items onboard (206); and the ordering system 102 sending out a notification to all prospective customers 100 in the targeted area, notifying them of the available food items and nearby delivery driver (208).

In embodiments, the list of menu items to be sold through the ordering system 102 and/or number thereof to be prepared is automatically generated.

In embodiments, driver check in is done automatically or semi-automatically, using data from the driver tracking module 106 and/or a restaurant's 110 point of sale system 108.

In embodiments, the notification to users in a targeted area is a push notification, a text message, or similar notification.

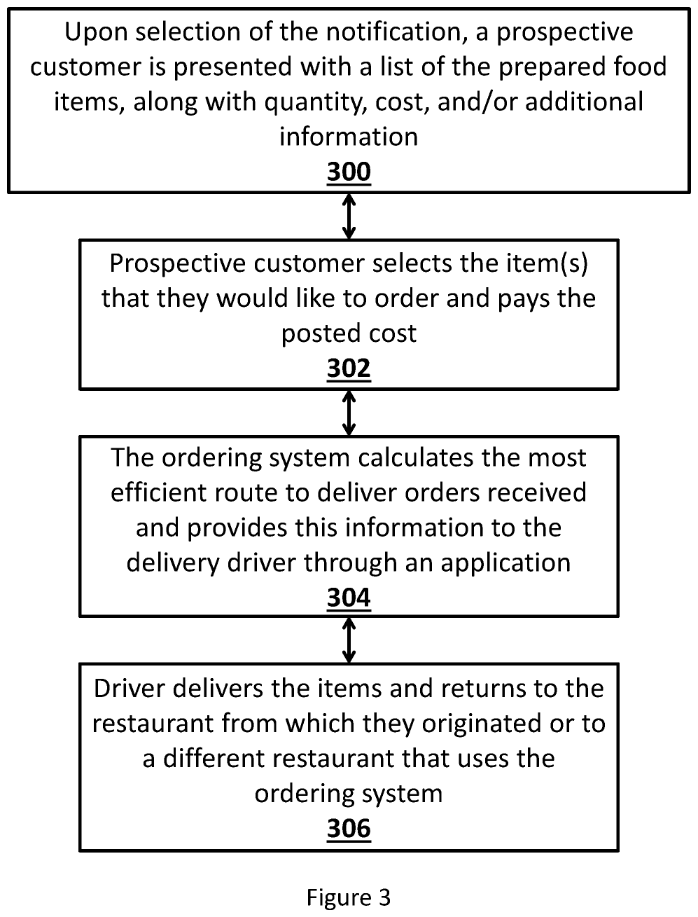

Now referring to FIG. 3, a flowchart illustrating a delivery system and method from the perspective of a user thereof is depicted. More specifically, the method of FIG. 3 comprises: after receiving a notification, upon the selection thereof, presenting the prospective customer 100 with a list of available, prepared food items, along with quantity, cost, and/or additional information (300); the prospective customer 100 may then select items that they would like to order, following which they are asked to pay for the selected items (302); after paying for the selected item(s), the ordering system 102, in embodiments, calculates the most efficient route to deliver orders received and provides this information to the delivery driver through an application (304); and the driver then delivers the items and returns to the restaurant 110 from which they originated or to a different restaurant that uses the ordering system 102 (306). In embodiments, the locations of drivers, restaurants 110, and/or customers (i.e. prospective customers 100 who have placed an order and become paying customers) using the systems and methods described herein are mapped in real-time, with the locations of drivers and restaurants 110 visible to customers and prospective customers 100 and the locations of prospective customers 100 and/or customers available to drivers and restaurants 110.

In embodiments, the delivery service 104 is a restaurant or other provide of food that has existing delivery capabilities while, in other embodiments, the delivery service 104 is a standalone entity that delivers food made by others.

In embodiments, incentives to place orders are provided to prospective customers 100. Incentives may be provided to prospective customers 100 through text message, push notifications, or other means, as would be known to one of ordinary skill in the art. In some cases, incentives are automatically offered based on pre-established criteria (e.g. if an order is cancelled after it is made, the order is offered for sale at a discounted rate).

In some cases, very limited time incentives are provided to encourage prospective customers 100 to make certain purchases, such as those that would increase the efficiency of or reduce the waste associated with the food delivery service 104. For instance, if a food delivery service 104 schedules a delivery to a certain area, the ordering system 102 may notify prospective customers 100, through an app, web browser, or similar medium, that a driver will be passing through their area shortly and offer a discount on food ordered within a certain time period or before the delivery driver departs.

In other cases, it may be more efficient for a restaurant 110 to make a large number of similar items simultaneously. For example, if an order is placed for a buffalo chicken finger meal, whether 3 tenders or 10 tenders are cooked simultaneously, the time to cook and equipment tied up in the cooking thereof will remain substantially the same. To incentivize prospective customers 100 to make such purchases, in embodiments, a short term discount is offered on types of food that would benefit from this efficiency (e.g. any style of chicken finger, pizza with chicken fingers as a topping, salads with chicken fingers, etc.).

In embodiments, the delivery service 104 is independent of any particular provider of food and simply purchases food, possibly at a discount, from a single or multiple restaurants 110 or other providers of food for resale. In embodiments, popular food items are purchased prior to any orders therefore being placed. The food items are then loaded into a delivery vehicle and offered for sale to prospective customers 100 located within a certain, predefined area around the vehicle (e.g. a five mile radius) through an app, web browser, or similar medium, in embodiments using push notifications, text messages, and/or the like. The vehicle then is driven to areas in which the food items are thought to be desired, i.e. a targeted area, and sold through an application, web browser, or similar medium. As the driver moves, the target area, in embodiments, expands, allowing the offer to reach additional prospective customers.

In embodiments, food from multiple restaurants 110 or other providers of food may be ordered by prospective customers 100. In some such embodiments, popular items from multiple restaurants 110 or other providers of food are bought by a food delivery service 104 and offered to prospective customers 100 through the ordering system 102 as described herein, allowing them to order their favorite dishes from multiple providers without having to place multiple orders and tip for multiple deliveries, assuming that each delivery could be made separately, given potential minimums often associated with delivery orders.

In embodiments, the area in which notifications pertaining to available food are broadcast is automatically adjusted based on population density and/or the presence of certain establishments where the available food is more likely to be ordered, such as dorms.

In embodiments, prospective customers 100 are allowed to schedule times at which they're interested in receiving deals. In other embodiments, deals are only available while the ordering system 102 is open, such as in an app or web browser, allowing the ordering system 102 itself to capture more of a prospective customer's 100 attention than would otherwise be the case. In still other embodiments, a prospective customer 100 with a predictable ordering pattern is prompted to order their usual order at the time they normally might, increasing both the ease of ordering and the likelihood that an order is placed.

In embodiments, the ordering system 102 further comprises a data analytics system that provides food delivery services 104 and/or restaurants 110 and other providers of food with various information that can be used to improve the efficiency of their operations, such as types of food ordered grouped by time and date, delivery locations, etc.

In embodiments, using data analytics, food for a specific individual or VIP is prepared in advance and, if not ordered, sold at a discount.

In embodiments, prospective customers 100 are allowed to request that the food delivery service 104 make a stop or stops along their route to deliver additional items, which may be non-food items.

Restaurants 110, as used herein, should be understood to comprise any establishment selling goods fit for consumption, including convenient stores, grocery stores, and the like.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

1: A method of food delivery, the method comprising:
preparing at least one food item or meal for sale; and
after the food item or meal is fully prepared, offering the prepared food item or meal for sale to prospective customers within a pre-defined delivery area.

2: The method of claim 1 wherein said predefined delivery area is a pre-defined radius around the food item or meal's location.

3: The method of claim 1 wherein said predefined delivery area is and area around a delivery vehicle containing the prepared food item or meal.

4: The method of claim 1 wherein the prepared food item or meal is offered for sale through an application or web browser based ordering system.

5: The method of claim 1 wherein the prepared food item or meal is offered for sale using push notifications.

6: The method of claim 1 wherein the prepared food item or meal is offered for sale using text messages.

7: The method of claim 1 further comprising, after fully preparing the food item or meal but before offering it for sale, loading the food item or meal into a delivery vehicle and driving the delivery vehicle towards a new location.

8: The method of claim 7 wherein said predefined delivery area is and area around a delivery vehicle containing the prepared food item or meal.

9: A method of food delivery, the method comprising:
purchasing at least one prepared food item or meal; and
offering the prepared food item or meal for sale to prospective customers within a pre-defined delivery area.

10: The method of claim 9 wherein said predefined delivery area is a pre-defined radius around the food item or meal's location.

11: The method of claim 9 wherein said predefined delivery area is and area around a delivery vehicle containing the prepared food item or meal.

12: The method of claim 9 wherein the prepared food item or meal is offered for sale through an application or web browser based ordering system.

13: The method of claim 9 wherein the prepared food item or meal is offered for sale using push notifications.

14: The method of claim 9 wherein the prepared food item or meal is offered for sale using text messages.

15: The method of claim 9 further comprising, after fully preparing the food item or meal but before offering it for sale, loading the food item or meal into a delivery vehicle and driving the delivery vehicle towards a new location.

16: The method of claim 15 wherein said predefined delivery area is and area around a delivery vehicle containing the prepared food item or meal.

17: A food delivery system, the system comprising:
an ordering system configured to list food available for purchase to prospective customers through a web browser or application;
at least one food delivery service in communication with said ordering system, wherein said at least one food delivery service updates said ordering system with food available for purchase; and
at least one driver tracking system configured to alert prospective customers of a delivery driver with available-to-purchase food nearby.

18: The food delivery system of claim 17 wherein said food available for purchase is fully prepared food.

19: The food delivery system of claim 17 wherein said at least one food delivery service updates said ordering system automatically through at least one point of sale system.

20: The food delivery system of claim 17 further comprising a means of communication between a delivery service driver and said prospective customers.
